(19) United States
(12) Patent Application Publication
(10) Pub. No.: US 2013/0196166 A1
(43) Pub. Date: Aug. 1, 2013

(54) Film Composition and Method of Making the Same

(71) Applicant: Pang Chia Lu, Pittsford, NY (US)

(72) Inventor: Pang Chia Lu, Pittsford, NY (US)

(21) Appl. No.: 13/640,969

(22) PCT Filed: Apr. 18, 2011
(86) PCT No.: PCT/US11/32911

§ 371 Date: Dec. 18, 2012

Related U.S. Application Data
(60) Provisional application No. 61/353,070, filed on Jun. 9, 2010.

(51) Int. Cl. B32B 27/08; B32B 15/085

(52) U.S. Cl. CPC B32B 27/08; B32B 15/085
USPC 428/462; 428/523; 428/461; 427/250

(57) ABSTRACT

This disclosure relates to a film that includes a first layer, the first layer includes a) 65.0 to 94.5 wt % of a first polymer; b) 0.5 to 10.0 wt % of a hydrocarbon resin; and c) 5.0 to 25.0 wt % of an elastomeric propylene-ethylene copolymer having an isotactic propylene triad tacticity of from 65 to 95%, a melting point by DSC equal to or less than 110° C., a heat of fusion of from 5.0 to 50.0 J/g, the elastomeric propylene-ethylene copolymer having: (1) propylene-derived units in an amount of at least 75 wt %; (2) ethylene-derived units in an amount of at least 6 wt %; and (3) optionally, 10 wt % or less of diene-derived units.

### CROSS-REFERENCE TO RELATED APPLICATIONS

This application claims priority from U.S. Provisional Application Ser. No. 61/353,070, filed Jun. 9, 2010, the content of which is incorporated by reference in its entirety.

### FIELD OF THE INVENTION

This invention relates generally to a film composition and the method of making the same. More particularly this invention relates to a film composition comprising a blend of a polyolefin and a metallocene catalyzed polyolefin copolymer, which has high metal adhesion.

### BACKGROUND OF THE INVENTION

Metallized films may be used as a barrier web to provide product protection in flexible packages. For example, a sealable high barrier film may be used in the inside of a chip bag, which requires very low moisture and oxygen transmission rates. Very low transmission rates would be defined as oxygen transmission rate (OTR) less than about 20, preferably less than about 15 cc/m²/day/atm and water vapor transmission rate (WVTR) less than about 0.5, preferably less than about 0.2 g/m²/day. To consistently achieve very low OTR and WVTR, transmission rates, high metal adhesion is required.

It is desirable for a metallized film to have adequate adhesion between the vapor-deposited metal layer and the film's metal receiving layer. Often, the higher the bond strength between the metal receiving layer of a film and the metal layer, the better. Higher metal adhesion can result in a more robust film in terms of barrier properties, lamination bond strengths and improvement on metal pick-off and loss during the packaging process when the film is dragged over the forming collar on Vertical Form Fill Seal (VFFS) machines. More specifically, by improving the metal adhesion, barrier properties are improved by minimizing the amount of metal pick-off and loss during the vacuum metallizing process and rewinding process. Package lamination bond strengths are improved when a metallized film with high metal adhesion is used in a multi-layer lamination. In thick multi-layer bags with many gussets and folds in the sealed areas (e.g., stand-up pouches), the metal layer often delaminates from the metal receiving layer. This can cause package failure or result in a “bag within a bag” phenomenon. Accordingly, films having high metal adhesion properties are highly desirable.

Aesthetic appearance is also important. It is desired that the metal surface of a metallized film has a bright, shiny, reflective appearance. Such a shiny metal appearance is especially desirable when the package includes bright, reflective metal in the finished graphics.

Another aspect of metallized polymer film is to ensure that the metal layer does not “craze” during extrusion lamination processes. Due to the high heat load from the molten polymer, the metal receiving layer may melt or deform and can fracture and crack. This will degrade gas and moisture vapor barrier properties of a film.

Preparation and metallization of a polymeric metal receiving layer, such as a metal receiving layer comprising Zeigler-Natta catalyzed polypropylene homopolymer (z-nPP), is a difficult process. Surface treatment, which facilitates low transmission rates and high metal adhesion to the surface of the metal receiving layer, breaks down the surface's polymer chains to produce low molecular weight oligomeric materials (LMWOM) on the surface. After metallization, low molecular weight oligomeric materials may break away from the surface causing the metal adhesion to be poor.

In addition, for polypropylene (PP) and other high melting point polymeric materials (about 155 to 168° C.), scratches generated in the machine direction orientation (MDO) can be a persistent problem. Frequent cleaning of the MDO rolls may be required to maintain good appearance. High percentage of scratches is observed for a blend of z-nPP and propylene-butene (PB) copolymers that melt above ˜148° C.

US Patent Application No. 2007/0292682 describes laminate films including a polyolefin base layer, and a metal receiving layer including a blend of propylene homopolymer or mini-random propylene-ethylene copolymer, and an amorphous poly-alpha-olefin or propylene-ethylene elastomer. The metal receiving layer may also include an propylene-ethylene copolymer. The laminate film may also include additional layers such as an additional polyolefin resin-containing layer, a metal layer, or combinations thereof.

Low melting point polymeric materials (about 120° C. to about 150° C.) have better traction property during the MDO process. Defects formed in the MDO process tend to melt and smooth over in the oven of the transverse direction orientation (TDO) process. However, using a propylene-based material with a melting point lower than ˜148° C. makes the surface much more susceptible to crazing during extrusion lamination.

Adding propylene-ethylene (EP) copolymer, low molecular weight waxes or hydrocarbon resins to polypropylene resin improves metal adhesion but increases crazing tendency and barrier degradation under strain. Also, adding too much Zeigler-Natta catalyzed ethylene-polypropylene (z-nEP) copolymer increases transmission rates.

Therefore, there is a need to develop a film having very low transmission rates, high metal adhesion and low craze in extrusion lamination process.

### SUMMARY OF THE INVENTION

It has been found that the presence of an elastomeric propylene-ethylene copolymer, a first polymer, e.g., polypropylene, and a hydrocarbon resin provides a film having a surface with an acceptable balance of metal adhesion and transmission rate while reduced haze.

Thus, in one aspect, embodiments of the invention provide a film comprising a first layer, the first layer, comprising:
a) 65.0 to 94.5 wt % of a first polymer, based on the combined weight of components a), b), and c);
b) 0.5 to 10.0 wt % of a hydrocarbon resin, based on the combined weight of components a), b), and c); and
c) 5.0 to 25.0 wt %, based on the combined weight of components a), b), and c), of an elastomeric propylene-ethylene copolymer having an isotactic propylene triad tacticity of from 65 to 95%, a melting point by DSC equal to or less than 110° C., a heat of fusion of from 5.0 to 50.0 J/g, the elastomeric propylene-ethylene copolymer comprising:
   (1) propylene-derived units in an amount of at least 75 wt %; based on the combined weight of components (1), (2), and (3);
   (2) ethylene-derived units in an amount of at least 6 wt. %, based on the combined weight of components (1), (2), and (3); and
   (3) optionally, 10 wt % or less of diene-derived units, based on the combined weight of components (1), (2), and (3).

In another aspect, embodiments of the invention provide a film comprising a first layer, wherein the first layer comprises:
a) 65.0 to 94.5 wt % of a first polymer, e.g., a polypropylene homopolymer or a mini-random propylene copolymer, particularly a mini-random propylene copolymer comprising ≦1.0 wt % ethylene-derived units;
b) 5.0 to 25.0 wt % of a poly-alpha-olefin; and
c) 0.5 to 10.0 wt % of a hydrocarbon resin, the amounts based on the combined weight of components a), b), and c).

In another aspect, embodiments of the invention provide a film comprising:
a) a first layer having a first side and a second side, wherein the first layer comprises (i) a first polymer; (ii) 1.0 to 5.0 wt % of a hydrocarbon resin; and (iii) 10.0 to 20.0 wt % of an elastomeric propylene-ethylene copolymer having an isotactic propylene triad tacticity of from 65% to 95%, a melting point by DSC equal to or less than 110° C., a heat of fusion of from 5 to 50 J/g, the elastomeric propylene-ethylene copolymer comprising:
   (1) propylene-derived units in an amount of at least 75 wt %, based on the combined weight of components (1), (2), and (3);
   (2) ethylene-derived units in an amount of at least 6 wt %, based on the combined weight of components (1), (2), and (3);
   (3) optionally 10 wt % or less of diene-derived units, based on the combined weight of components (1), (2), and (3);
b) a core layer having a first side and a second side comprising polypropylene,
wherein the core layer is adjacent the first side of the first layer;
c) a vapor-deposited metal layer in surface contact with the second side of the first layer; and
d) a tie layer between the first side of the first layer and the first side of the core layer.

In another aspect, embodiments of the invention provide a method of making film of claim comprising:
a) extruding a blend of the first polymer, the elastomeric propylene-ethylene copolymer, and the hydrocarbon resin to form the first layer, optionally co-extruding the blend with at least one polymeric material to form a first layer of a multilayer film;
b) optionally, orienting the film in at least one of MD, TD, or both; and
c) optionally, metallizing the first layer.

In particular embodiments, the first polymer comprises a first polypropylene homopolymer or mini-random propylene copolymer, e.g., a propylene copolymer comprising ≦1.0 wt % ethylene-derived units.

In some embodiments, the elastomeric propylene-ethylene copolymer comprises ≦20.0 wt %, ≦15.0 wt %, or ≦9.0 wt % ethylene-derived units. In some embodiments, the first layer comprises 10.0 to 25 wt % of the elastomeric propylene-ethylene copolymer or the poly-alpha-olefin.

Typical hydrocarbon resins include petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C. In particular embodiments, the hydrocarbon is a light steam-cracked naphtha petroleum resin.

Embodiments of the first layer include a second polypropylene homopolymer or mini-random propylene copolymer having a different ethylene content or molecular weight than the first polypropylene homopolymer or mini-random propylene copolymer.

In particular embodiment, the films of the invention also include a vacuum-deposited metal layer comprising at least one of aluminum, silver, copper, gold, silicon, germanium, iron, or nickel. Embodiments of the invention may also include a coating layer.

### DETAILED DESCRIPTION OF THE PREFERRED EMBODIMENTS

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, “polymer” may be used to refer to homopolymers, copolymers, interpolymers, terpolymers, etc.

As used herein, unless specified otherwise, the term “copolymer(s)” refers to polymers formed by the polymerization of at least two different monomers. For example, the term “copolymer” includes the copolymerization reaction product of ethylene and an alpha-olefin (α-olefin), such as 1-hexene. However, the term “copolymer” is also inclusive of, for example, the copolymerization of a mixture of ethylene, propylene, 1-hexene, and 1-octene.

As used herein, unless specified otherwise, the term “terpolymer(s)” refers to polymers formed by the polymerization of at least three distinct monomers.

As used herein, unless specified otherwise, the term “elastomer” refers to a polymer with the property of elasticity.

As used herein the term “mini-random propylene copolymer” refers to a polymer comprising 97.5 to 99.5 wt % of polymer units derived from propylene monomer and 0.5 to 2.5 wt % of polymer units derived from at least one other monomer, particularly an a-olefin, e.g., ethylene.

As used herein the term “homopolymer” refers to a polymer comprising at least 99.5 wt %, preferably 99.9 wt %, of units derived from a single monomer, e.g., propylene.

As used herein, the term “crazing” refers to micro-cracks present on a film surface, which has been described in EP-1864793A1; WO-2008/033622A2; and WO-2004/033195A1, the entireties of which are incorporated by reference. In particular, references to metal crazing in this disclosure refer to fine cracks in the metal layer that stacked along the transverse direction (TD) which typically form under external heat and/or stress conditions.

As used herein, weight percent (“wt %”), unless noted otherwise, means a percent by weight of a particular component based on the total weight of the mixture containing the component. For example, if a mixture or blend contains three grams of compound A and one gram of compound B, then the compound A comprises 75 wt % of the mixture and the compound B comprises 25 wt %.

As used herein, the term molecular weight refers to the weight average molecular weight (Mw) unless otherwise specified. A molecular weight of polymer is considered different from the molecular weight of another polymer if the reported molecular weight of the polymer having the lower reported weight average molecular weights differs by at least 5% from the molecular weight reported for the polymer having the higher molecular weight. Where the melt flow rate (MFR) is used to reflect the molecular weight of the polymers, a molecular weight of polymer is considered different from the molecular weight of another polymer if the reported MFR of the polymer having the lower reported MFR differs by at least 5% from the molecular weight reported for the polymer having the higher MFR.

### The First Polymer

The first layer of the multilayer film comprises 65.0 to 94.5 wt % of a first polymer. In some embodiments, the first layer comprises 70.0 to 90.0, or 75 to 85.0 wt % of the first polymer. In some embodiments the first layer is a metal receiving layer. The first polymer may be a polymer of an olefin monomer having 2 to 10 carbons. Examples of first polymer include polyethylene, polypropylene, and isotactic propylene homopolymer. Suitable isotactic propylene homopolymers for the first polymer include e.g., ExxonMobil PP 4712, TOTAL EOD02-19 or TOTAL 3576X. In preferred embodiments the first polymer comprises a polypropylene homopolymer or mini-random propylene copolymer, e.g., a propylene copolymer comprising ≦2.0 wt %, preferably ≦1.0 wt %, ethylene-derived units.

### The Elastomeric Propylene-Ethylene Copolymer

The first layer generally includes about 5.0 to 25.0 wt %, particularly 10.0 to 25.0 wt %, more particularly 10.0 to 20.0 wt % of an elastomeric propylene-ethylene copolymer having an isotactic propylene triad tacticity of from 65 to 95%, a melting point by DSC equal to or less than 110° C., a heat of fusion of from 5 to 50 J/g, the elastomeric propylene-ethylene copolymer comprising:
(1) propylene-derived units in an amount of at least 75 wt %, based on the combined weight of components (1), (2), and (3);
(2) ethylene-derived units in an amount of at least 6 wt %, based on the combined weight of components (1), (2), and (3); and
(3) optionally 10 wt % or less of diene-derived units, based on the combined weight of components (1), (2), and (3).

In certain embodiments, the elastomeric propylene-ethylene copolymer has a melting temperature (Tₘ) in the range of 60° C. to about 150° C., preferably in the range of about 80° C. to about 150° C., or in the range of about 60° C. to about 140° C., more preferably in the range of about 80° C. to about 120° C., and most preferably in the range of about 85° C. to about 110° C.

Some elastomeric propylene-ethylene copolymers have a single peak melting transition as determined by DSC; in certain embodiments the elastomeric propylene-ethylene copolymer has a primary peak melting transition from less than 90° C., with a broad end-of-melt transition from greater than about 110° C. The peak “melting point” (Tₘ) is defined as the temperature of the greatest heat absorption within the range of melting of the sample. However, the elastomeric propylene-ethylene copolymer may show secondary melting peaks adjacent to the principal peak, and/or the end-of-melt transition, but for purposes herein, such secondary melting peaks are considered together as a single melting point, with the highest of these peaks being considered the Tₘ of the elastomeric propylene-ethylene copolymer. The elastomeric propylene-ethylene copolymers have a peak melting temperature (Tₘ) from about 60 or 70 or 80 or 90 or 100 or 105° C. to less than about 100 or 110 or 120 or 130 or 135 or 136 or 138 or 139 or 140 or 145 or 150 or 155 or 160° C., in some embodiments.

The procedure for DSC determinations is as follows. About 0.5 grams of polymer is weighed out and pressed to a thickness of about 15 to 20 mils (about 381 to 508 microns) at about 140° C. to 150° C., using a “DSC mold” and Mylar™ as a backing sheet. The pressed pad is allowed to cool to ambient temperature by hanging in air (the Mylar is not removed). The pressed pad is annealed at room temperature (about 23° C. to 25° C.) for about 8 days. At the end of this period, an about 15 to 20 mg disc is removed from the pressed pad using a punch die and is placed in a 10 μliter aluminum sample pan. The sample is placed in a differential scanning calorimeter (Perkin Elmer Pyris 1 Thermal Analysis System) and cooled to about −100° C. The sample is heated at about 10° C./min to attain a final temperature of about 165° C. The thermal output, recorded as the area under the melting peak of the sample, is a measure of the heat of fusion and can be expressed in Joules per gram (J/g) of polymer and is automatically calculated by the Perkin Elmer System. Under these conditions, the melting profile shows two (2) maxima, the maximum at the highest temperature was taken as the melting point within the range of melting of the sample relative to a baseline measurement for the increasing heat capacity of the polymer as a function of temperature.

In certain embodiments, the elastomeric propylene-ethylene copolymer comprises ethylene or C₄ to C₁₀ α-olefin-derived units (or “comonomer-derived units”) within the range from 5.0 or 7.0 or 8.0 or 10.0 to 11.0 wt % by weight of the copolymer. The elastomeric propylene-ethylene copolymer may also comprise two different comonomer-derived units. Also, these copolymers and terpolymers may comprise diene-derived units as described below. In a particular embodiment, the elastomeric propylene-ethylene copolymer comprises propylene-derived units and comonomer units selected from ethylene, 1-hexene and 1-octene. And in a more particular embodiment, the comonomer is ethylene, and thus the elastomeric propylene-ethylene copolymer is an elastomeric propylene-ethylene copolymer.

In one embodiment, the elastomeric propylene-ethylene copolymer comprises from less than 10.0 or 8.0 or 5.0 or 3.0 wt % of the copolymer or terpolymer, of diene derived units (or “diene”), and within the range from 0.1 or 0.5 or 1.0 to 5.0 or 8.0 or 10.0 wt % in yet another embodiment. Suitable dienes include for example: 1,4-hexadiene, 1,6-octadiene, 5-methyl-1,4-hexadiene, 3,7-dimethyl-1,6-octadiene, dicyclopentadiene (DCPD), ethylidiene norbornene (ENB), norbornadiene, 5-vinyl-2-norbornene (VNB), and combinations thereof. The diene, if present, is most preferably ENB.

In certain embodiments, the elastomeric propylene-ethylene copolymers have a triad tacticity of three propylene units, as measured by ¹³C NMR, from greater than 75% or 80% or 82% or 85% or 90%. In one embodiment, the triad tacticity is within the range from 50 to 99%; from 60 to 99% in another embodiment; from 75 to 99% in yet another embodiment; from 80 to 99% in yet another embodiment; and from 60 to 97% in yet another embodiment. Triad tacticity is determined as follows. The tacticity index, expressed herein as “m/r”, is determined by ¹³C nuclear magnetic resonance (NMR). The tacticity index m/r is calculated as defined by H. N. Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios from greater than 50. Embodiments of the elastomeric propylene-ethylene copolymer have a tacticity index m/r within the range from 4 or 6 to 8 or 10 or 12.

In certain embodiments, the elastomeric propylene-ethylene copolymers have a heat of fusion (H_{f}), determined according to the Differential Scanning calorimetry (DSC) procedure described herein, within the range from 0.5 or 1 or 5 J/g, to 35 or 40 or 50 or 65 or 75 J/g. In certain embodiments, the H_{f} value is from less than 75 or 65 or 55 J/g.

In certain embodiments, the elastomeric propylene-ethylene copolymers have a percent crystallinity within the range from 0.5 to 40%; from 1 to 30% in another embodiment; and from 5 to 25% in yet another embodiment, wherein “percent crystallinity” is determined according to the DSC procedure described herein. (The thermal energy for the highest order of polypropylene is estimated at 189 J/g (i.e., 100% crystallinity is equal to 189 J/g).) In another embodiment, the elastomeric propylene-ethylene copolymer has a percent crystallinity from less than 40% or 25% or 22% or 20%.

In certain embodiments, the elastomeric propylene-ethylene copolymers have a density within the range from 0.840 to 0.920 g/cm³; from 0.845 to 0.900 g/cm³ in another embodiment; and from 0.850 to 0.890 g/cm³ in yet another embodiment, the values measured at room temperature per the ASTM D-1505 test method.

In certain embodiments, the elastomeric propylene-ethylene copolymers have a Shore A hardness (ASTM D2240) within the range from 10 or 20 to 80 or 90 Shore A. In yet another embodiment, the elastomeric propylene-ethylene copolymers possess an Ultimate Elongation from greater than 5.0×10²% or 1.0×10³% or 2.0×10³%; and within the range from 3.0×10²% or 4.0×10²% or 5.0×10²% to 8.0×10²% or 1.2×10³% or 1.8×10³% or 2.0×10³% or 3.0×10³% in other embodiments.

In certain embodiments, the elastomeric propylene-ethylene copolymers have a weight average molecular weight (Mw) value within the range from 2.0×10⁴ to 5.0×10⁶ g/mole; from 5.0×10⁴ to 1×10⁶ g/mole in another embodiment; and from 7.0×10⁴ to 4.0×10⁵ g/mole in yet another embodiment. In another embodiment, the elastomeric propylene-ethylene copolymers have a number average molecular weight (Mn) value within the range from 4.5×10³ to 2.5×10⁶ g/mole; from 2.0×10⁴ to 2.5×10⁵ g/mole in yet another embodiment; and from 5.0×10⁴ to 2.0×10⁵ g/mole in yet another embodiment. In yet another embodiment, the elastomeric propylene-ethylene copolymers have a z-average molecular weight (Mz) value within the range from 2.0×10⁴ to 7.0×10⁶ g/mole; from 1.0×10⁵ to 7.0×10⁵ g/mole in another embodiment; and from 1.4×10⁵ to 5.0×10⁵ g/mole in yet another embodiment.

In certain embodiments, the elastomeric propylene-ethylene copolymers have a melt flow rate (“MFR,” ASTM D1238, 2.16 kg, 230° C.), from less than 90 or 70 or 50 or 40 or 30 or 20 or 10 dg/min, and within the range from 0.1 or 0.5 or 1 or 5 or 10 to 20 or 30 or 40 or 50 or 70 or 90 dg/min in other embodiments.

In certain embodiments, a desirable molecular weight (and hence, a desirable MFR) is achieved by visbreaking the elastomeric propylene-ethylene copolymers. “Visbroken elastomeric propylene-ethylene copolymers” (also known in the art as “controlled rheology” or “CR”) are copolymers that have been treated with a visbreaking agent such that the agent breaks apart the polymer chains. Non-limiting examples of visbreaking agents include peroxides, hydroxylamine esters, and other oxidizing and free-radical generating agents. Stated another way, the visbroken copolymer may be the reaction product of a visbreaking agent and the copolymer. In particular, a visbroken elastomeric propylene-ethylene copolymer is one that has been treated with a visbreaking agent such that its MFR is increased, in one embodiment by at least 10%, and at least 20% in another embodiment relative to the MFR value prior to treatment.

In certain embodiments, the molecular weight distribution (MWD) of the elastomeric propylene-ethylene copolymers is within the range from 1.5 or 1.8 or 2.0 to 3.0 or 3.5 or 4.0 or 5.0 or 10.0 in particular embodiments. Techniques for determining the molecular weight (Mn, Mz, and Mw) and molecular weight distribution (MWD) are as follows, and as by Verstate et al. in 21 MACROMOLECULES 3360 (1988). Conditions described herein govern over published test conditions. Molecular weight and molecular weight distribution are measured using a Waters 150 gel permeation chromatograph equipped with a Chromatix KMX-6 on-line light scattering photometer. The system is used at 135° C. with 1,2,4-trichlorobenzene as the mobile phase. Showdex™ (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes Ed., Marcel Dekker, 1981). No corrections for column spreading were employed; however, data on generally accepted standards, for example, National Bureau of Standards, Polyethylene (SRM 1484) and anionically produced hydrogenated polyisoprenes (an alternating propylene-ethylene copolymer) demonstrate that such corrections on Mw/Mn or Mz/Mw are less than 0.05 units. Mw/Mn is calculated from an elution time-molecular weight relationship whereas Mz/Mw is evaluated using the light scattering photometer. The numerical analyses can be performed using the computer software GPC2, MOLWT2 available from LDC/Milton Roy-Riviera Beach, Fla.

Elastomeric propylene-ethylene copolymers are also described in WO 05/049670, the disclosure of which is incorporated herein by reference in its entirety.

The elastomeric propylene-ethylene copolymers described herein can be produced using any catalyst and/or process known for producing polypropylenes. In certain embodiments, the elastomeric propylene-ethylene copolymers can include copolymers prepared according to the procedures in WO 02/36651; U.S. Pat. No. 6,992,158; and/or WO 00/01745. Preferred methods for producing the elastomeric propylene-ethylene copolymers are found in US Patent Application Publication 2004/0236042 and U.S. Pat. No. 6,881,800. Preferred propylene-based polyolefin polymers are available commercially under the trade names Vistamaxx™ (ExxonMobil Chemical Company, Houston, Tex., USA) and Versify™ (The Dow Chemical Company, Midland, Mich., USA), certain grades of Tafiner™ XM or Notio™ (Mitsui Company, Japan) or certain grades of Softell™ (LyondellBasell Polyolefine GmbH, Germany). A commercial example of an ethylene-based polyolefin copolymer is Infuse™ olefin block copolymers (Dow Chemical). In some embodiments, the second polymer of the metal receiving layer is a metallocene-catalyzed propylene-ethylene copolymer having an ethylene content of less than about 11.0 wt %, preferably less than about 9.0 wt %, and more preferably less than about 8.0 wt %. Suitable metallocene-catalyzed propylene-ethylene copolymers include ExxonMobil Chemical's Vistamaxx™ series of elastomers, particularly Vistamaxx™ 3000 having an ethylene content of 11 wt % and Vistamaxx™ 3980 having an ethylene content of 9 wt %. Other suitable EP elastomers include DOW CHEMICAL VERSIFY elastomers, particularly grades DP3200.01 having an ethylene content of 9 wt %, and Mitsui Chemical's Nitio™ series having Tm about 100° C. or greater, such as, PN-2070, PN-3560, PN-0040, and PN-2060.

### The Amorphous Poly-Alpha-Olefin

Rather than an elastic propylene-ethylene copolymer, some embodiments of the invention include a first layer that comprises an amorphous poly-alpha-olefin (aPAO). Generally, the aPAO is present in place of and in the same amounts as the elastic propylene-ethylene copolymer. Of course, mixtures of aPAO and an elastic propylene-ethylene copolymer may also be used. Typically, the amorphous poly-alpha-olefin comprises an aliphatic hydrocarbon, or paraffin, typically comprising C₆ to C₂₀₀ paraffins. The term “paraffins”, as used herein, includes all isomers of C₆ to C₂₀₀ paraffins including branched and linear structures, and blends thereof. The individual paraffins may include saturated cyclic hydrocarbons. Some amorphous poly-alpha-olefins have a pour point of less than 0° C., and a viscosity (ASTM D445-97) of from 0.1 to 3000 cSt at 100° C.

Particular aPAOs are non-functionalized. As used herein the term “non-functionalized aPAO” refers to a compound comprising carbon and hydrogen, and does not include to an appreciable extent functional groups selected from hydroxide, aryls and substituted aryls, halogens, alkoxys, carboxylates, esters, carbon unsaturation, acrylates, oxygen, nitrogen, and carboxyl. By “appreciable extent”, it is meant that these groups and compounds comprising these groups are not deliberately added to the non-functionalized aPAO, and if present at all, are present to less than 5 wt % by weight of the non-functionalized aPAO in one embodiment, and less than 1 wt % in another embodiment, and less than 0.5 wt % in yet another embodiment.

In one embodiment, the non-functionalized aPAO consists of C₆ to C₂₀₀ paraffins, and C₈ to C₁₀₀ paraffins in another embodiment. In another embodiment, the non-functionalized aPAO consists essentially of C₆ to C₂₀₀ paraffins, and consists essentially of C₈ to C₁₀₀ paraffins in another embodiment. For purposes of the present invention and description herein, the term “paraffin” includes all isomers such as n-paraffins, branched paraffins, isoparaffins, and may include cyclic aliphatic species, and blends thereof, and may be derived synthetically by means known in the art, or from refined crude oil in such a way as to meet the requirements described for desirable non-functionalized aPAOs described herein. It will be realized that the classes of materials described herein that are useful as non-functionalized aPAOs can be utilized alone or admixed with other non-functionalized aPAOs described herein as may be desirable to reduce hazing.

The non-functionalized aPAO may have a dielectric constant at 20° C. of less than 3.0 in one embodiment, less than 2.8 in another embodiment, less than 2.5 in another embodiment, less than 2.3 in yet another embodiment, and less than 2.1 in yet another embodiment. Polyethylene and polypropylene each have a dielectric constant (1 kHz, 23° C.) of at least 2.3 (CRC HANDBOOK OF CHEMISTRY AND PHYSICS (David R. Lide Ed., 82^{nd} Ed. CRC Press 2001).

The non-functionalized aPAO has a viscosity (ASTM D445-97) of from 0.1 to 3000 cSt at 100° C., from 0.5 to 1000 cSt at 100° C. in another embodiment, from 1 to 250 cSt at 100° C. in another embodiment, from 1 to 200 cSt at 100° C. in yet another embodiment, and from 10 to 500 cSt at 100° C. in yet another embodiment, wherein a desirable range may comprise any upper viscosity limit with any lower viscosity limit described herein.

The non-functionalized aPAO has a specific gravity (ASTM D 4052, 15.6/15.6° C.) of less than 0.920 g/cm³ in one embodiment, less than 0.910 g/cm³ in another embodiment, from 0.650 to 0.900 g/cm³ in another embodiment, from 0.700 to 0.860 g/cm³, from 0.750 to 0.855 g/cm³ in another embodiment, from 0.790 to 0.850 g/cm³ in another embodiment, and from 0.800 to 0.840 g/cm³ in yet another embodiment, wherein a desirable range may comprise any upper specific gravity limit with any lower specific gravity limit described herein. The non-functionalized aPAO has a boiling point of from 100° C. to 800° C. in one embodiment, from 200° C. to 600° C. in another embodiment, and from 250° C. to 500° C. in yet another embodiment. Further, the non-functionalized aPAO has a weight average molecular weight (GPC or GC) of less than 20,000 g/mol in one embodiment, less than 10,000 g/mol in yet another embodiment, less than 5,000 g/mol in yet another embodiment, less than 4,000 g/mol in yet another embodiment, less than 2,000 g/mol in yet another embodiment, less than 500 g/mol in yet another embodiment, and greater than 100 g/mol in yet another embodiment, wherein a desirable molecular weight range can be any combination of any upper molecular weight limit with any lower molecular weight limit described herein.

Non-functionalized aPAOs useful in embodiments of the invention may be selected from compounds such as so called “isoparaffins”, “polybutenes” and polydecenes (both subgroups of PAOs). These three classes of compounds can be described as paraffins which can include branched, cyclic, and normal structures, and blends thereof. These NFPs can be described as comprising C₆ to C₂₀₀ paraffins in one embodiment, and C₈ to C₁₀₀ paraffins in another embodiment.

Some suitable amorphous poly-alpha-olefin materials include those manufactured by Degussa AG under the trade name VESTOPLAST™ and grade names EP X22 and EP X35. These are propylene-ethylene-butene low molecular weight, amorphous, atactic terpolymers. VESTOPLAST™ poly-alpha-olefins comprise about 35 wt % ethylene and 10 wt % butene. They are characterized by a melt viscosity at 190° C. of 220 and 350 Pa-s, respectively; a T_{g} of −32° C.; a softening point of 163° C.; a melt flow rate at 230° C. of 180 to 200 and 138 g/10 minutes, respectively; and a molecular weight of 130,000 and 170,000 g/mol, respectively. DEGUSSA EP X35 is preferred in some embodiments due to its higher molecular weight. Another suitable source for aPAO materials are from Ube Industries, Ltd. CAP 330 and CAP 350 grades. These materials are blends of aPAO at 30 wt % and 50 wt %, respectively, in a mini-random copolymer carrier resin to produce a masterbatch. These aPAO masterbatches have melt flow indexes at 190° C. of 3.8 and 14.0 g/10 minutes, respectively; a T_{g} of −13 and −15° C., respectively; a Vicat softening point of 105 and 68° C., respectively (per ASTM D1225); and density of 0.887 and 0.879, respectively. These aPAO's are in contrast to typical propylene-ethylene-butene terpolymers used for heat sealant resin layers in coextruded BOPP films such as SUMITOMO SPX78H8 which are long-chain, high molecular weight polymers with a correspondingly significantly lower MFR of 8 to 11 g/10 minutes at 230° C., and molecular weights on the order of 350,000 to 400,000 g/mol.

### The Hydrocarbon Resin

The first layer also includes 0.5 wt % to 10.0 wt %, 0.8 wt % to 9.0 wt %, 1.2 wt % to 8.8 wt % or 1.5 wt % to about 7.5 wt % of a hydrocarbon resin. Hydrocarbon resins may serve to enhance or modify the modulus, improve processability, or improve the barrier properties of the film. Examples of such hydrocarbon resins may be found in U.S. Pat. No. 5,667,902, incorporated herein by reference. The resin may be a low molecular weight hydrocarbon, which is compatible with the core polymer. Optionally, the resin may be hydrogenated. The resin may have a number average molecular weight greater than 5.0×10³; preferably greater than 2.0×10³; most preferably in the range of from 5.0×10² to 1.0×10³. The resin can be natural or synthetic and may have a softening point in the range of from 60° to 180° C. (140° to 356° F.).

Examples of hydrocarbon resins that may be used include petroleum resins, aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, terpene resins, polyterpene resins, terpene-phenol resins, styrene resins, cyclopentadiene resins, rosins and rosin esters, hydrogenated rosins and rosin esters, grafted resins and mixtures of two or more thereof. Some suitable resins a softening point of 110 to 180° C.

Hydrocarbon resins that may be suitable for use as described herein include EMPR 120, 104, 111, 106, 112, 115, EMFR 100 and 100A, ECR-373 and Escorez™ 2101, 2203, 2520, 5380, 5600, 5618, 5690, available from ExxonMobil Chemical Company; ARKON™ M90, M100, M115 and M135 and SUPER ESTER™ rosin esters available from Arakawa Chemical Company of Japan; SYLVARES™ phenol modified styrene-a methyl styrene resins, styrenated terpene resins, ZONATAC terpene-aromatic resins, and terpene phenolic resins available from Arizona Chemical Company; SYLVATAC™ and SYLVALITE™ rosin esters available from Arizona Chemical Company; NORSOLENE™ aliphatic aromatic resins available from Cray Valley of France; DERTOPHENE™ terpene phenolic resins available from DRT Chemical Company of Landes, France; EASTOTAC™ resins, PICCOTAC™ C₅/C₉ resins, REGALITE™ and REGALREZ™ aromatic and REGALITE™ cycloaliphatic/aromatic resins available from Eastman Chemical Company of Kingsport, Tenn.; WINGTACK™ ET and EXTRA available from Goodyear Chemical Company, FORAL™, PENTALYN™, and PERMALYN™ rosins and rosin esters available from Hercules (now Eastman Chemical Company); QUINTONE™ acid modified C₅ resins, C₅/C₉ resins, and acid modified C₅/C₉ resins available from Nippon Zeon of Japan; and LX™ mixed aromatic/cycloaliphatic resins available from Neville Chemical Company; CLEARON hydrogenated terpene aromatic resins available from Yasuhara; and Piccolyte. The preceding examples are illustrative only and by no means limiting.

One particular hydrocarbon resin may be referred to as a saturated alicyclic resin. Such resins, if used, may have a softening point in the range of from 85° C. to 140° C. (185° F. to 284° F.), or preferably in the range of 100° C. to 140° C. (212° F. to 284° F.), as measured by the ring and ball technique. Examples of saturated alicyclic resins are Arkon-P™ (from Arakawa Forest Chemical Industries, Ltd., of Japan).

Other suitable resins and there methods of manufacture are described in U.S. Pat. No. 7,495,048, the disclosure of which is incorporated herein by reference in its entirety.

### Film Structures and Embodiments

In some embodiments, the film useful for this disclosure may further comprise additional layer(s), such as core layer, skin layer, sealant layer, tie layer, metal deposit layer, and any combination thereof. The film may be oriented uniaxially or biaxially.

In other embodiments, the additional layer(s) of the film may comprise a propylene polymer, ethylene polymer, isotactic polypropylene (“iPP”), high crystallinity polypropylene (“HCPP”), low crystallinity polypropylene, isotactic and syndiotactic polypropylene, propylene-ethylene (“EP”) copolymers, and combinations thereof.

The film of this disclosure may be uniaxially or biaxially oriented. Orientation in the direction of extrusion is known as machine direction (“MD”) orientation. Orientation perpendicular to the direction of extrusion is known as transverse direction (“TD”) orientation. Orientation may be accomplished by stretching or pulling a film first in the MD followed by the TD. Orientation may be sequential or simultaneous, depending upon the desired film features. Preferred orientation ratios are commonly from between about 3 to about 6 times in the machine direction (MD) and between about 4 to about 10 times in the traverse direction (TD).

The metal receiving surface of the film may be surface-treated to increase the surface energy of the film to render the film receptive to metallization, coatings, printing inks, and/or lamination. The surface treatment can be carried out according to one or several of the methods known in the art. Preferred methods include, but are not limited to, corona discharge, flame treatment, plasma treatment, chemical treatment, or treatment by means of a polarized flame.

The surface of the metal receiving layer may be metallized using conventional methods, such as vacuum deposition of at least one metal such as aluminum, silver, copper, gold, silicon, germanium, iron, nickel, chromium, or mixtures thereof.

### Additives

One or more layers of the film, such as the metal receiving layer, may further contain one or more additives. Examples of useful additives include, but are not limited to, opacifying agents, pigments, colorants, cavitating agents, slip agents, antioxidants, anti-fog agents, anti-static agents, anti-block agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required.

Examples of suitable opacifying agents, pigments, or colorants include, but are not limited to, iron oxide, carbon black, aluminum, titanium dioxide, calcium carbonate, poly terephthalate, talc, beta nucleating agents, and combinations thereof.

Cavitating agents or void-initiating particles may be added to one or more layers of the film to create an opaque film. Preferably, the cavitating agents or void-initiating particles are added to the core layer. Generally, the cavitating or void-initiating additive includes any suitable organic or inorganic material that is incompatible with the polymer material(s) contained in the layer(s) to which the cavitating or void-initiating additive is added, at the temperature of biaxial orientation. Examples of suitable void-initiating particles include, but are not limited to, polybutylene teraphthalate (“PBT”), nylon, cyclic-olefin copolymers, solid or hollow pre-formed glass spheres, metal beads or spheres, ceramic spheres, calcium carbonate, talc, chalk, or combinations thereof. The average diameter of the void-initiating particles typically ranges from about 0.1 μm to 10 μm. The particles may be of any desired shape, or preferably they are substantially spherical in shape. Preferably, the cavitating agents or void-initiating particles are present in the layer at less than 30 wt %, or less than 20 wt %, or most preferably in the range of 2 wt % to 10 wt %, based on the total weight of the layer. Alternatively, one or more layers of the film may be cavitated by beta nucleation, which includes creating beta-form crystals of polypropylene and converting at least some of the beta-crystals to alpha-form crystals thus leaving small voids remaining after the conversion.

Slip agents that may be used include, but are not limited to, higher aliphatic acid amides, higher aliphatic acid esters, waxes, silicone oils, and metal soaps. Such slip agents may be used in amounts in the range of 0.1 wt % to 2 wt % based on the total weight of the layer to which it is added. An example of a fatty acid slip additive that may be used is erucamide. In one embodiment, a conventional polydialkylsiloxane, such as silicone oil or silicone gum, additive having a viscosity of 10,000 to 2,000,000 cSt is used.

Non-migratory slip agents may be used in one or more of the outer surface layers of the films. Non-migratory means that these agents do not generally change location throughout the layers of the film in the manner of migratory slip agents. A preferred non-migratory slip agent is polymethyl methacrylate (“PMMA”). The non-migratory slip agent may have a mean particle size in the range of 0.5 μm to 15 μm, or 1 μm to 10 μm, or 1 μm to 5 μm, or 2 μm to 4 μm, depending on the layer's thickness and desired slip properties. Alternatively, the size of the particles in the non-migratory slip agent, such as PMMA, may be greater than 10% of the thickness of the surface layer containing the slip agent, or greater than 20% of the layer's thickness, or greater than 50% of the layer's thickness, or greater than 100% of the layer's thickness. Generally spherical, particulate non-migratory slip agents are contemplated. An example of a PMMA resins is EPOSTAR™ which is available from Nippon Shokubai Co., Ltd. of Japan.

An example of a suitable antioxidant includes phenolic anti-oxidants, such as IRGANOX® 1010, from Ciba-Geigy Company of Switzerland. Such an antioxidant may be used in an amount ranging from 0.1 wt % to 2 wt %, based on the total weight of the layer to which it is added.

Anti-static agents that may be used include alkali metal sulfonates, polyether-modified polydiorganosiloxanes, polyalkylpheylsiloxanes, tertiary amines, glycerol mono-sterate, blends of glycerol mono-sterate and tertiary amines, and combinations thereof. Such anti-static agents may be used in amounts in the range of about 0.05 wt % to 3 wt %, based on the total weight of the layer to which the anti-static is added. An example of a suitable anti-static agent is ARMOSTAT™ 475, from Akzo Nobel.

Useful antiblock additives include, but are not limited to, silica-based products such as inorganic particulates such as silicon dioxide, calcium carbonate, magnesium silicate, aluminum silicate, calcium phosphate, and the like. Other useful antiblock additives include polysiloxanes and non-meltable crosslinked silicone resin powder, such as TOSPEARL™, from Toshiba Silicone Co., Ltd. Anti-blocking agents may be effective in amounts up to about 30,000 ppm of the layer to which it is added.

Examples of useful fillers include but are not limited to, finely divided inorganic solid materials such as silica, fumed silica, diatomaceous earth, calcium carbonate, calcium silicate, aluminum silicate, kaolin, talc, bentonite, clay, and pulp.

Suitable moisture and gas barrier additives may include effective amounts of low-molecular weight resins, hydrocarbon resins, particularly petroleum resins, styrene resins, cyclopentadiene resins, and terpene resins. The film may also contain a hydrocarbon wax in one or more layers. The hydrocarbon wax may be either a mineral wax or a synthetic wax. Hydrocarbon waxes may include paraffin waxes and microcrystalline waxes. Typically, paraffin waxes having a broad molecular weight distribution are preferred as they generally provide better barrier properties than paraffin waxes with a narrow molecular weight distribution.

Optionally, one or more of the outer surface layers may be compounded with a wax or coated with a wax-containing coating, for lubricity, in amounts in the range of 2 wt % to 15 wt % based on the total weight of the layer.

### Coatings

One or more coatings, such as for barrier, printing, and/or processing, may be applied to one or both of the outer surfaces of the films. Preferably, the coating is not applied to surface of the metal receiving layer prior to the metal deposition. Such coatings may include acrylic polymers, such as ethylene acrylic acid (“EAA”), ethylene methyl acrylate copolymers (“EMA”), polyvinylidene chloride (“PVdC”), poly(vinyl)alcohol (“PVOH”), ethylene(vinyl)alcohol (“EVOH”), and combinations thereof.

1. Thus, particular embodiments include a film comprising a first layer, the first layer, comprising:
a) 65.0 to 94.5 wt % of a first polymer, based on the combined weight of components a), b), and c);
b) 0.5 to 10.0 wt % of a hydrocarbon resin, based on the combined weight of components a), b), and c); and
c) 5.0 to 25.0 wt % based on the combined weight of components a), b), and c), of an elastomeric propylene-ethylene copolymer having an isotactic propylene triad tacticity of from 65 to 95%, a melting point by DSC equal to or less than 110° C., a heat of fusion of from 5.0 to 50.0 J/g, the elastomeric propylene-ethylene copolymer comprising:
   (1) propylene-derived units in an amount of at least 75 wt %; based on the combined weight of components (1), (2), and (3);
   (2) ethylene-derived units in an amount of at least 6 wt %, based on the combined weight of components (1), (2), and (3); and
   (3) optionally 10 wt % or less of diene-derived units, based on the combined weight of components (1), (2), and (3).
      2. In particular embodiments of the film of paragraph 1, the first polymer comprises a first polypropylene homopolymer or first mini-random propylene copolymer, e.g., a mini-random propylene copolymer comprising ≦1.0 wt % ethylene-derived units.
      3. In particular embodiments of the films of paragraphs 1 and 2, the elastomeric propylene-ethylene copolymer comprises ≦9.0 wt % ethylene-derived units.
      4. The film of any of paragraphs 1 to 3, wherein the first layer comprises 10.0 to 25.0 wt % of the elastomeric propylene-ethylene copolymer.
      5. The film of any of paragraphs 1 to 4, wherein the first layer comprises 1.0 to 5.0 wt % of the hydrocarbon resin.
      6. The film of any of paragraphs 1 to 5, wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.
      7. The film of any of paragraphs 1 to 6, wherein the hydrocarbon is a light steam-cracked naphtha petroleum resin.
      8. The film of any of paragraphs 2 to 7, wherein the first layer includes a second polypropylene homopolymer or second mini-random propylene copolymer having a different ethylene content or molecular weight than the first polypropylene homopolymer or mini-random propylene copolymer.
      9. The film of any of paragraphs 1 to 8, further comprising a second polymeric layer in surface contact with the first layer, particularly where the second polymeric layer is a core layer, optionally comprising one or more tie layers.
      10. In particular embodiments, the film comprises a first layer, wherein the first layer comprises:
a) 65.0 to 94.5 wt % of a first polymer;
b) 5.0 to 25.0 wt % of a poly-alpha-olefin; and
c) 0.5 to 10.0 wt % of a hydrocarbon resin, the amounts based on the combined weight of components a), b), and c).
   11. The film of paragraph 10, wherein the first polymer comprises a polypropylene homopolymer or a mini-random propylene copolymer.
   12. The film of paragraph 10 or 11, wherein the first polymer comprises a mini-random propylene copolymer comprising ≦1.0 wt % ethylene-derived units.
   13. The film of any one of paragraphs 10 to 12, wherein the first layer comprises 10.0 to 25 wt % of the poly-alpha-olefin.
   14. The film of any one of paragraphs 10 to 13, wherein the first layer comprises 1.0 to 5.0 wt % of the hydrocarbon resin.
   15. The film of any one of paragraphs 10 to 14, wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.
   16. The film of any one of paragraphs 10 to 15, wherein the hydrocarbon is a light steam-cracked naphtha petroleum resin.
   17. The film of any previous paragraph, further comprising a second polymeric layer.
   18. A film comprising:
a) a first layer having a first side and a second side, wherein the first layer comprises (i) a first polymer; (ii) 1.0 to 5.0 wt % of a hydrocarbon resin; and (iii) 10 to 20 wt % of an elastomeric propylene-ethylene copolymer having an isotactic propylene triad tacticity of from 65% to 95%, a melting point by DSC equal to or less than 110° C., a heat of fusion of from 5 to 50 J/g, the elastomeric propylene-ethylene copolymer comprising:
   (1) propylene-derived units in an amount of at least 75 wt %, based on the combined weight of components (1), (2), and (3);
   (2) ethylene-derived units in an amount of at least 6 wt %, based on the combined weight of components (1), (2), and (3); and
   (3) optionally, 10 wt % or less of diene-derived units, based on the combined weight of components (1), (2), and (3).
b) a core layer having a first side and a second side comprising polypropylene, wherein the core layer is adjacent the first side of the first layer;
c) a vapor-deposited metal layer in surface contact with the second side of the first layer; and
d) a tie layer between the first side of the first layer and the first side of the core layer.
   19. The film of paragraph 18, wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.
   20. The film of any previous paragraph, further including a vacuum-deposited metal layer comprising at least one of aluminum, silver, copper, gold, silicon, germanium, iron, or nickel.
   21. The film of any previous paragraph, further comprising a coating layer.
   22. A method of making film of any preceding paragraph comprising:
a) extruding a blend of the first polymer, the elastomeric propylene-ethylene copolymer, and the hydrocarbon resin to form the first layer, optionally co-extruding the blend with at least one polymeric material to form a first layer of a multilayer film;
b) optionally, orienting the film in at least one of MD, TD, or both; and
c) optionally, metallizing the first layer.
   23. The method of paragraph 22, further including providing the hydrocarbon resin as a mixture comprising the hydrocarbon resin and a second polymer different from the first polymer, optionally the second polymer being a polypropylene homopolymer or a mini-random propylene-ethylene copolymer comprising ≦1 wt % ethylene-derived units.
   24. The method of paragraph 22 or 23, further comprising providing a coating layer in surface contact with the first layer and or the optional metal layer.

### Examples 1 to 3

In Examples 1 to 3, three-layer coextruded films with structure as metal-accepting skin/core layer/sealant skin are produced on a tenter-frame extrusion-orientation line. The coextruded basesheet is stretched in the machine direction (MD) for 5× and transverse direction (TD) for 8×. The metal-accepting skin layer is varied with different resin blends. The oriented base films' haze levels are measured and their appearances are compared. Then, corona treated example films are metallized in a vacuum chamber with aluminum deposited onto the metal receiving skin to reach an optical density of 2.4. The appearances of the metallized film surface are compared and barrier properties measured.

An example of a representative film structure is shown in Table 1.

TABLE
Representative Film Structure of Films in Examples 1 to 3

| | | | Gauge | |
|---|---|---|---|---|
| Layer | Structure/Resin | Thickness/μm | (mil) | % |
| Sealant Skin | EPB Terpolymer | 0.76 | 0.03 | 4.3 |
| Core | Polypropylene | 15.7 | 0.62 | 88.6 |
| Metal receiving | Skin Blend | 1.3 | 0.05 | 7.1 |
| Skin | | | | |

### Example 1

In Example 1, the metal receiving skin layer comprises 100 wt % polypropylene homopolymer (Grade PP-4712 resin from ExxonMobil Chemical Company).

### Example 2

In example 2, the metal receiving skin layer comprises 85.0 wt % of the polypropylene homopolymer PP-4712 resin and 15.0 wt % of an elastomeric propylene-ethylene copolymer having a density of 0.879 g/cm³, a melt flow rate (2.1 kg, 230° C.), and an ethylene content of about 8.5 wt % (available as Vistamaxx-3980 from ExxonMobil Chemical Company).

### Example 3

In Example 3, the metal receiving layer comprises 80.0 wt % of the polypropylene homopolymer PP-4712 resin, 15.0 wt % Vistamaxx-3980 and 5.0% of a hydrocarbon resin masterbatch 1 (available as OPPERA 609A which is 50% hydrocarbon resin in a polypropylene homopolymer carrier resin available from ExxonMobil Chemical Company).

The film properties are listed in Table 2. (OTR as oxygen transmission rate, cc/m² at 73° F.-0% RH).

TABLE 2
Comparison of film Properties for Examples 1 to 3

| | | base film | | metallized film | | |
|---|---|---|---|---|---|---|
| | metal receiving | | % | | metal | |
| Example # | skin | appearance | haze | appearance | adhesion | OTR |
| 1 | PP-4712 | smooth, glossy | 1.1 | shinny | low | 15 |
| 2 | PP-4712 + 15.0% | grainy, dull | 11.0 | dull | medium | 25 |
| | Vistamaxx-3980 | | | | | |
| 3 | PP-4712 + 15.0% | smooth, glossy | 3.2 | shinny | high | 15 |
| | Vistamaxx-3980 + | | | | | |
| | 5.0% PA-609A | | | | | |

The data in Table 2 show that the addition of the hydrocarbon resin substantially reduces the undesirable effects introduced by the addition of the propylene-ethylene elastomer in the film. The films of Example 3 have a surprising reduction in haze, a shinny metal surface appearance, and an OTR that is comparable to the OTR of the metallized film of Example 1.

The foregoing examples have been provided merely for the purpose of explanation and are in no way to be construed as limiting of this disclosure. While this disclosure has been described with reference to a number of exemplary embodiments, it is understood that the words which have been used herein are words of description and illustration, rather than words of limitation. Although this disclosure has been described herein with reference to particular means, materials and embodiments, this disclosure is not intended to be limited to the particulars disclosed herein; rather, the present invention extends to all functionally equivalent structures, methods and uses, such as are within the scope of the appended claims.

1. A film comprising at least a first skin layer, a tie layer and a core layer, the first skin layer, comprising:
a) 65.0 to 94.5 wt % of a first polymer, based on the combined weight of components a), b), and c);
b) 0.5 to 10.0 wt % of a hydrocarbon resin, based on the combined weight of components a), b), and c); and
c) 5.0 to 25.0 wt %, based on the combined weight of components a), b), and c), of an elastomeric propylene-ethylene copolymer having an isotactic propylene triad tacticity of from 65 to 95%, a melting point by DSC equal to or less than 110° C., a heat of fusion of from 5.0 to 50.0 J/g, the elastomeric propylene-ethylene copolymer comprising:
(1) propylene-derived units in an amount of at least 75 wt %; based on the combined weight of components (1), (2), and (3);
(2) ethylene-derived units in an amount of at least 6 wt %, based on the combined weight of components (1), (2), and (3); and
(3) optionally, 10 wt % or less of diene-derived units, based on the combined weight of components (1), (2), and (3).

2. The film of claim 1, wherein the first polymer comprises a first polypropylene homopolymer or first mini-random propylene copolymer.

3. The film of claim 1, wherein the first polymer comprises a mini-random propylene copolymer comprising ≦1.0 wt % ethylene-derived units.

4. The film of claim 1 wherein the elastomeric propylene-ethylene copolymer comprises ≦9.0 wt % ethylene-derived units.

5. The film of claim 1, wherein the first layer comprises 10.0 to 25.0 wt % of the elastomeric propylene-ethylene copolymer.

6. The film of claim 1, wherein the first layer comprises 1.0 to 5.0 wt % of the hydrocarbon resin.

7. The film of claim 1 wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.

8. The film of claim 1, wherein the hydrocarbon is a light steam-cracked naphtha petroleum resin.

9. The film of claim 2, wherein the first layer includes a second polypropylene homopolymer or second mini-random propylene copolymer having a different ethylene content or molecular weight than the first polypropylene homopolymer or mini-random propylene copolymer.

10. The film of claim 1, further comprising a second polymeric layer in surface contact with the first layer.

11. A film comprising a first layer, wherein the first layer comprises:
a) 65.0 to 94.5 wt % of a first polymer;
b) 5.0 to 25.0 wt % of a poly-alpha-olefin; and
c) 0.5 to 10.0 wt % of a hydrocarbon resin, the amounts based on the combined weight of components a), b), and c).

12. The film of claim 11, wherein the first polymer comprises a polypropylene homopolymer or a mini-random propylene copolymer.

13. The film of claim 11, wherein the first polymer comprises a mini-random propylene copolymer comprising ≦1.0 wt % ethylene-derived units.

14. The film of claim 11, wherein the first layer comprises 10.0 to 25 wt % of the poly-alpha-olefin.

15. The film of claim 11, wherein the first layer comprises 1.0 to 5.0 wt % of the hydrocarbon resin.

16. The film of claim 11, wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.

17. The film of claim 11, wherein the hydrocarbon is a light steam-cracked naphtha petroleum resin.

18. The film of claim 11, further comprising a second polymeric layer.

19. A film comprising:
a) a first skin layer having a first side and a second side, wherein the first layer comprises (i) a first polymer; (ii) 1.0 to 5.0 wt % of a hydrocarbon resin; and (iii) 10 to 20 wt % of a an elastomeric propylene-ethylene copolymer having an isotactic propylene triad tacticity of from 65 to 95%, a melting point by DSC equal to or less than 110° C., a heat of fusion of from 5 to 50 J/g, the elastomeric propylene-ethylene copolymer comprising:
(1) propylene-derived units in an amount of at least 75 wt %, based on the combined weight of components (1), (2), and (3);
(2) ethylene-derived units in an amount of at least 6 wt %, based on the combined weight of components (1), (2), and (3); and
(3) optionally, 10 wt % or less of diene-derived units, based on the combined weight of components (1), (2), and (3).
b) a core layer having a first side and a second side comprising polypropylene, wherein the core layer is adjacent the first side of the first layer;
c) a vapor-deposited metal layer in surface contact with the second side of the first layer; and
d) a tie layer between the first side of the first layer and the first side of the core layer.

20. The film of claim 19, wherein the hydrocarbon resin comprises petroleum resin, terpene resin, styrene resin, cyclopentadiene resin, saturated alicyclic resin, and combinations thereof, said resin having a number average molecular weight of less than 5,000 g/mol, said resin having a softening point in the range of from 60° C. to 180° C.

21. The film of claim 19, further including a vacuum-deposited metal layer comprising at least one of aluminum, silver, copper, gold, silicon, germanium, iron, or nickel.

22. The film of claim 19, further comprising a coating layer.

23. A method of making film of claim 19 comprising:
a) extruding a blend of the first polymer, the elastomeric propylene-ethylene copolymer, and the hydrocarbon resin to form the first layer, optionally co-extruding the blend with at least one polymeric material to form a first layer of a multilayer film;
b) optionally, orienting the film in at least one of MD, TD, or both; and
c) optionally, metallizing the first layer.

24. The method of claim 23, further including providing the hydrocarbon resin as a mixture comprising the hydrocarbon resin and a second polymer different from the first polymer, optionally the second polymer being a polypropylene homopolymer or a mini-random propylene-ethylene copolymer comprising ≦1 wt % ethylene-derived units.

25. The method of claim 23, further comprising providing a coating layer in surface contact with the first layer and or the optional metal layer.
